(19) United States
(12) Patent Application Publication
(10) Pub. No.: US 2001/0037369 A1
(43) Pub. Date: Nov. 1, 2001

(54) Method of assigning an e-mail address

(76) Inventor: Jin-Yong Joo, Seoul (KR)

Correspondence Address: JACOBSON HOLMAN PLLC, 400 SEVENTH STREET N.W., SUITE 600, WASHINGTON, DC, 20004, US

(21) Appl. No.: 09/837,417

(22) Filed: Apr. 19, 2001

(30) Foreign Application Priority Data
Apr. 28, 2000 (KR) 2000-22658

(51) Int. Cl. G06F 15/16

(52) U.S. Cl. 709/206; 709/245

(57) ABSTRACT

The present invention relates to a method of assigning an e-mail address with a user chosen ID. More particularly, the present invention relates to a method of assigning an e-mail address with a user chosen ID by employing a website which does not currently provide a web mail service. According to the present invention, a user doesn't have to visit many websites to get an e-mail address with his or her chosen ID. Furthermore, the website which provides a web mail service by assigning an e-mail address according to this invention can gain an advantage over other websites providing a web mail service, and therefore, can raise more members.

### BACKGROUND OF THE INVENTION

1. Field Of the Invention

The present invention relates to a method of assigning an e-mail address with a user chosen ID, more particularly, to a method of assigning an e-mail address with a user chosen ID by employing a website which does not provide a web mail service.

2. Description of Related Art

Currently, general websites do not provide a web mail service, a service sending and receiving e-mails through a web, but allow sending and receiving e-mails for the authorized personnel or staffs of the websites.

Furthermore, a website providing a web mail service for users assigns an e-mail address by combining the domain name with the ID chosen by a user. However, these websites are limited in number and are already subscribed by a lot of people. So, a user has difficulty in getting an e-mail address with his or her chosen ID.

Therefore, if the chosen ID is already used by another user, the user has to give up the chosen ID and apply for another ID, or the user has to try another website providing a web mail service.

### SUMMARY OF THE INVENTION

Therefore, it is an object of the present invention to provide a method of assigning an e-mail address according to the user chosen ID by solving the aforementioned problems.

To this end, the present invention provides a method of assigning an e-mail address comprising:

(A) a step of collecting a website which does not provide a web mail service for public by a website which provides a web mail service for public and equips with a web server and the first database stored already offered e-mail addresses of a website which provides a web mail service for public and storing already offered e-mail addresses of a website which does not provide a web mail service for public in the second database;

(B) a step of transmitting an input window for inputting a user chosen ID through the web server of the website providing a web mail service when a user connects to the website providing a web mail service for obtaining an e-mail address;

(C) a step of assigning and storing an e-mail address in the first database by combining the user chosen ID with the domain name of the website providing a web mail service if there is no duplicated ID after searching the first database by the web server which received the ID; and

(D) a step of assigning and storing an e-mail address in the second database by combining the user chosen ID with the domain name of the website in which the chosen ID is not occupied by another user after searching the second database by the web server if the chosen ID is already used by another user in the first database in the step (C).

### BRIEF DESCRIPTION OF THE DRAWINGS

FIG. 1 is a schematic diagram of a system performed by a method according to one example of the present invention.

FIG. 2 is a partial flow diagram of steps according to one example method of the present invention.

FIG. 3 is a partial flow diagram of steps according to one example method of the present invention.

### DETAILED DESCRIPTION OF THE INVENTION

Preferred embodiments of the invention will be described hereinafter with reference to the drawings.

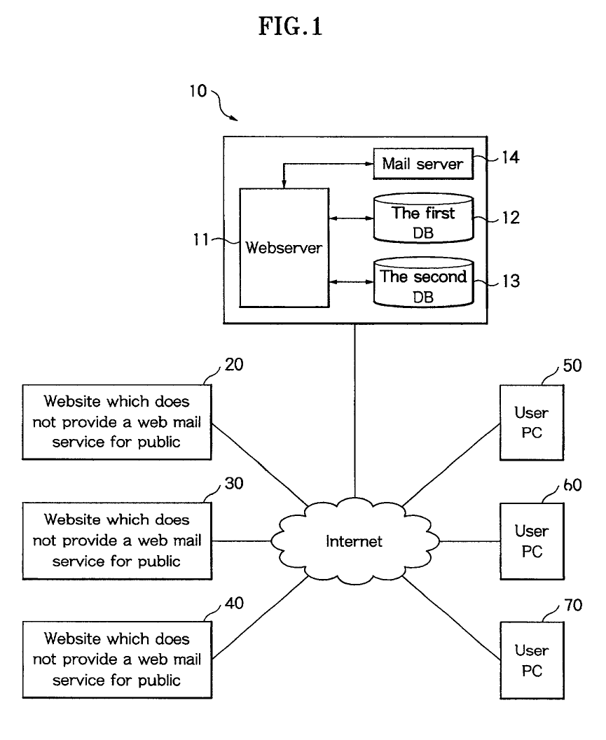

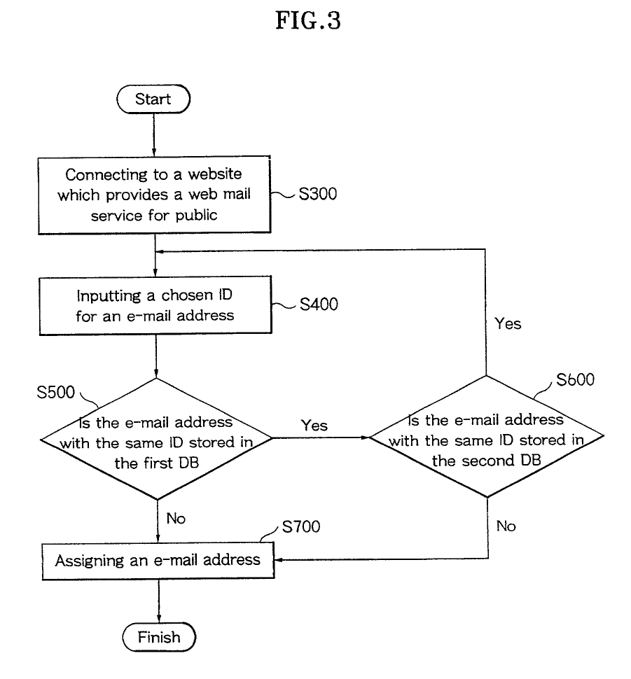

FIG. 1 is a schematic diagram of a system performed by a method according to one example of the present invention. In FIG. 1, a website 10 which provides a web mail service for users and comprises a web server 11, the first database 12 and the second database 13, websites 20, 30, 40, and user PC's 50, 60, 70 are connected by the internet network. There are only three user PC's and three websites which does not provide a web mail service for users are depicted in the FIG. 3, but there are numerous websites and user PC's in reality.

The web server 11 is a general web server that is designed to provide a window for inputting a user chosen ID and to search the first database 12 and the second database 13 for an e-mail address under the chosen ID in order to provide a web mail service. In other words, the web server 11 is a web server which is being employed in a website such as Yahoo or Lycos which provides a web mail service for users.

The first database 12 is a database which stores information such as e-mail addresses of users who are already served with an e-mail service through the website 10 providing a web mail service, and the second database 13 is a database which performs a method according to the present invention and stores information on e-mail addresses of the authorized managing personnel or staffs of the websites 20, 30, 40 which does not provide a web mail service for public but does so for the selected personnel and staffs out of necessity.

The first database 12 and the second database 13 are depicted as separate databases, but there is no problem in practicing the present invention even though they are actually one database. It is depicted separately just for division.

The interlocking relationship between the databases 12, 13 and the web server 11 can be constructed easily for the purpose of the present invention by applying CGI or ASP by those with appropriate knowledge in this field.

Furthermore, the mail server 14 is a mail server which sends a mail according to the request of user PC's 50, 60, 70, and stores a received mail and displays it upon the request of user PC's 50, 60, 70.

In FIG. 1, the mail server is depicted as equipped by the website 10, but the mail server from a mail server hosting company (not depicted) can serve for this purpose instead of being equipped by the website 10.

Moreover, in order to practice the present invention steadily it is desirable for the website 10 as well as websites 20, 30 and 40 which do not provide a web mail service to use the same mail server 14 for receiving e-mails. It is because that when an e-mail address of a user is determined using a domain name of a website 20, 30, 40 which does not provide a web mail service unlike the public website 10, one cannot confirm the arrival of an e-mail by connecting to the website 10. The e-mails can be confirmed only by connecting to the website 20, 30, 40, which is not easy because the websites 20, 30, 40 do not provide a web mail service.

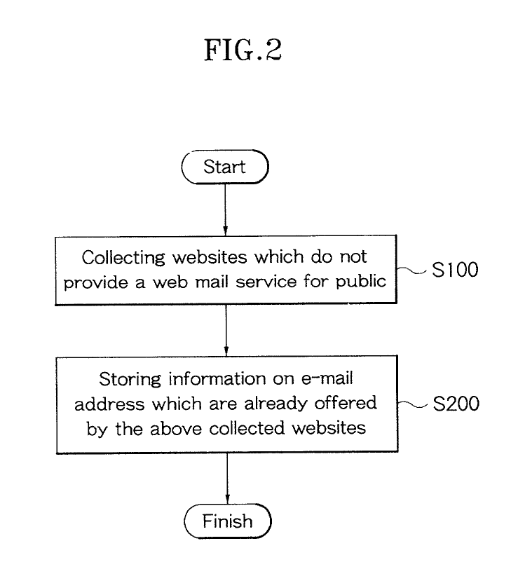

Hereinafter, preferred embodiments of the invention in the aforementioned system will be explained with reference to FIGS. 2 and 3.

Generally, an e-mail address is assigned by combining a user chosen ID with a domain name of a website providing a web mail service. Therefore, in order to assign an e-mail address according to the user chosen ID, a lot of domain name and the corresponding IP address should be secured. For this end, the website 10 which intends to assign an e-mail address according to this invention invites websites 20, 30, 40 which do not provide a web mail service. The website inviting method in this invention includes diverse methods such as an advertisement through mass media but it is not particularly limited to that.

The website 10 which plans to provide a service according to the present invention should be permitted for the use of domain name and IP address of the collected websites 20, 30, 40.

The collected websites 20, 30, 40 do not provide a public web mail service but they endow e-mail addresses for authorized personnel and staffs, and the website 10 stores information on the e-mail addresses which are endowed by the websites 20, 30, 40 in the second database S200 of the website 10. That is to say, the e-mail addresses with the ID endowed by the collected websites are assorted and stored according to a website.

In order to raise the chance for a user to have his or her chosen ID according to this invention, it is desirable to collect more websites that do not provide a web mail service at S 100 stage.

Through the aforementioned S100 and S200 stages, the necessary information to bestow an e-mail address with a user chosen ID is set up. The S100 and S200 stages are preparative stages to embody a method of the present invention.

After the preparative stages, the web server 11 of a website 10 transmits an input window for a user to input his or her chosen ID to user PC's 50, 60, 70 when a user connects to the website (see S300 of FIG. 3). The user input his or her chosen ID through his or her PC's 50, 60, 70, which is then transmitted back to the web server (see S400 of FIG. 3).

Upon receiving the user chosen ID, the web server 11 in first searches the first database 12 of the website which stores information on e-mail addresses bestowed in connection to the domain name to see whether there is the same ID occupied by another user (see S500 of FIG. 3).

If there is no e-mail address assigned to the chosen ID in the S500 stage, then an e-mail address made by combining the chosen ID and the domain name of the website 10 is assigned (see S700 of FIG. 3).

If another user already occupies an e-mail address according to the chosen ID, a message to input another ID is transmitted to the user PC by a web server according to existing methods. However, in the present invention, the web server 11 automatically searches the second database 13 to see whether another user occupies the same ID.

If a website which did not assign an e-mail address with the chosen ID is found after searching, an e-mail address made by combining the chosen ID and the domain name of the website is assigned to the user by the web server 11 (see S700 of FIG. 3). In this case the user is not served with a web mail service by connecting to the website whose domain name is assigned to the user's e-mail address but the user connects to the website 10 which provides the web mail service for a web mail service.

When an e-mail address of a user is determined by combining a domain name of a website which does not provide a web mail service for public, the user has to connect to the website 10 and to go through a user authorization process to see a received mail. In this case it 5 is desirable to use an e-mail address that is made by combining the initially chosen ID and the domain name for an ID for a user authorization.

For example, when a user wants to have an e-mail address under the ID of jyjoo through the website www.givemail.net, which is already occupied by another user, then the www.givemail.net searches information on websites which do not provide a web mail service. If there is no user using jyjoo as his or her e-mail address in www.inch21.net, then www.givemail.net assigns the e-mail address of jyjoo@inch21.net to the user. Under this circumstance, the www.inch21.net uses the same mail receiving server (POP3 server) with the wwwgivemail.net, and the user assigned the e-mail address of jyjoo@inch21.net can continuously have a web mail service at www.givemail.net. And in this situation, the user ID for an authorization in the www.givemail.net may be jyjoo@inch21.net.

The second database 13 has information on many websites raised in the S100 stage, and chances to bestow an e-mail address with a user chosen ID will be enhanced.

Furthermore, when a service to provide space for a homepage is carried out along with the assigning of an e-mail address in a website providing a web mail service according to the present invention, a user can assign the same file name where his or her homepage locates with the e-mail address. Therefore, the user will have an e-mail address with his or her chosen ID as well as a website in the same name which will enhance the user's loyalty to the website.

As explained above, the e-mail address assigning method of the present invention is beneficial to users because it eliminates the efforts to visit many websites to get an e-mail address according to his or her chosen ID.

Moreover, the website which provides a web mail service by assigning an e-mail address according to this invention can endow an e-mail address according to the user chosen ID, and can gain an advantage over other websites providing a web mail service. Therefore, it can raise more members, and the loyalty of the members for the website which provide a service of the present invention will be enhanced.

In addition, a general website which does not provide a public web mail service can win an advertising effect by numerous users who have e-mail addresses made by a domain name of its website. And the website which provides a web mail service by assigning an e-mail address according to the present invention can have an additional effect of networking the websites which join to gain the aforementioned advertising effects.

What is claimed is:

1. A method of assigning an e-mail address comprising:
(A) a step of collecting a website which does not provide a web mail service for public by a website which provides a web mail service for public and equips with a web server and the first database stored already offered e-mail addresses of a website which provides a web mail service for public and storing already offered e-mail addresses of a website which does not provide a web mail service for public in the second database;
(B) a step of transmitting an input window for inputting a user chosen ID through the web server of the website providing a web mail service when a user connects to the website providing a web mail service for obtaining an e-mail address;
(C) a step of assigning and storing an e-mail address in the first database by combining the user chosen ID with the domain name of the website providing a web mail service if there is no duplicated ID after searching the first database by the web server which received the ID; and
(D) a step of assigning and storing an e-mail address in the second database by combining the user chosen ID with the domain name of the website in which the chosen ID is not occupied by another user after searching the second database by the web server if the chosen ID is already used by another user in the first database in the step (C).

2. A method of assigning an e-mail address according to claim 1, wherein the website which provides a web mail service and the website which does not provide a web mail service use the same mail server.

3. A method of assigning an e-mail address according to claim 1, wherein a user can assign the same file name for his or her homepage with the e-mail address assigned in the above step (C) or step (D) when a service to provide space for a homepage is carried out along with the assigning of an e-mail address in the website providing a web mail service.
